(19) United States
(12) Patent Application Publication
(10) Pub. No.: US 2022/0343818 A1
(43) Pub. Date: Oct. 27, 2022

(54) LIGHT-EMITTING DEVICE, DISPLAY MODULE AND DRIVING METHOD THEREOF

(71) Applicant: Lite-On Technology Corporation, Taipei (TW)

(72) Inventors: Chin Kuan Lin, Taipei (TW); Ju Ling Cheng, Taipei (TW); Yi Chu Lin, Taipei (TW)

(73) Assignee: Lite-On Technology Corporation, Taipei (TW)

(21) Appl. No.: 17/726,547

(22) Filed: Apr. 22, 2022

Related U.S. Application Data
(60) Provisional application No. 63/180,055, filed on Apr. 26, 2021.

(30) Foreign Application Priority Data
Feb. 24, 2022 (CN) 202210174392.8

(51) Int. Cl. G09G 3/06

(52) U.S. Cl. CPC G09G 3/06; G09G 2310/0286; G09G 2310/0243; G09G 2370/00; G09G 2320/0247; G09G 2320/0233; G09G 2320/0257

(57) ABSTRACT

A light-emitting device, a display module, and a driving method thereof are disclosed. The light-emitting device including a data input, a data output, a plurality of light units, and a driving circuit. The data input is configured to receive an input data. The data output is adapted to be connected in series to a data input of another light-emitting device. The driving circuit is coupled to the data input, the data output, and the plurality of light units. The driving circuit statically drives the plurality of light units according to the input data, and generates an output data according to the input data and transmits the output data to the data output. The display module includes the light-emitting device and a control circuit.

### CROSS-REFERENCE TO RELATED APPLICATION

This application claims the priority benefits of U.S. Provision Application Ser. No. 63/180,055 filed on Apr. 26, 2021 and Chinese Application Serial No. 202210174392.8, filed on Feb. 24, 2022. The entirety of each of the above-mentioned patent applications is hereby incorporated by reference herein and made a part of this specification.

### BACKGROUND

### Technical Field

The disclosure relates to a light-emitting device. Particularly, the disclosure relates to a light-emitting device that may be connected in series, a display module, and a driving method thereof.

### Description of Related Art

On the market, there are many small display devices, such as a seven-segment display, an alphanumeric display, a mix-type display, and a dot-matrix display, among other small display devices, including a plurality of optical parts and configured to display symbols, numerical digits, words, and other information. Generally speaking, when a plurality of small display devices are adopted to display multiple pieces of information/data, the small display devices need to be driven through an external control circuit and driving circuit combined with active components and passive components (e.g., resistors and transistors) and adopting static scanning or dynamic scanning to achieve time-divisional driving/scanning switched between the display devices. However, in dynamic scanning, “point-to-column” multi-point time-divisional driving is realized by utilizing the persistence of vision of the human eye and adopting software for continuously cyclic driving. Since the scanning is required to be constantly updated, it is likely that flickering or ghosting occurs, or an unstable voltage causes insufficient display brightness or causes uneven display brightness of a plurality of light units inside the display device, for example. If the conventional static scanning is adopted, since “point-to-point” directly driving of the corresponding light units is required, a great number of input/output interfaces may be required, causing a high cost, a large volume, a complex control program, and the like.

### SUMMARY

The disclosure provides a light-emitting device, a display module, and a driving method thereof. The light-emitting device may be connected in series, and the number of ports required for static scanning is reduced.

According to an embodiment of the disclosure, a light-emitting device includes a data input, a data output, a plurality of light units, and a driving circuit. The data input is configured to receive an input data. The data output is adapted to be connected in series to a data input of another light-emitting device. The driving circuit is coupled to the data input, the data output, and the plurality of light units. The driving circuit statically drives the plurality of light units according to the input data, and generates an output data according to the input data and transmits the output data to the data output.

Based on the foregoing, in the light-emitting device according to the embodiments of the disclosure, the input data may be received by one data input, the plurality of light units may be statically driven by the driving circuit inside the light-emitting device according to the input data, and the output data may be generated according to the input data and transmitted to the data output by the driving circuit. Since the data output is adapted to be connected in series to the data input of another light-emitting device, multiple pieces of information/data may accordingly be delivered by the data inputs and the data outputs of the plurality of light-emitting devices connected in series to statically drive the plurality of light-emitting devices sequentially to perform display, addressing the requirements for a great number of input/output interfaces in the conventional static scanning, without generating flickering or ghosting in the dynamic driving, or an unstable voltage causing insufficient display brightness or causing uneven display brightness of the plurality of light units, for example.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is a schematic circuit block diagram of a light-emitting device according to an embodiment of the disclosure.

FIG. 2 is a schematic flowchart of a driving method of a light-emitting device according to an embodiment of the disclosure.

FIG. 3 is a schematic circuit block diagram of a display module according to an embodiment of the disclosure.

FIG. 4 is a schematic diagram showing an application scenario of the display module shown in FIG. 3 according to an embodiment of the disclosure.

FIG. 5 is a schematic circuit block diagram of a light-emitting device according to another embodiment of the disclosure.

FIG. 6 is a schematic diagram showing distribution and transmission of the input data shown in FIG. 5 according to an embodiment of the disclosure.

### DESCRIPTION OF THE EMBODIMENTS

Reference will now be made in detail to exemplary embodiments of the disclosure, examples of which are illustrated in the accompanying drawings. Wherever possible, the same reference numerals are used in the drawings and the description to refer to the same or similar parts.

The term “coupling (or connection)” as used throughout this specification (including the claims) may refer to any direct or indirect means of connection. For example, if it is herein described that a first device is coupled (or connected) to a second device, it should be interpreted that the first device may be directly connected to the second device, or the first device may be indirectly connected to the second device through other devices or some connection means. The terms “first” and “second” mentioned through out the description (including the claims) are used to name components, or to distinguish between different embodiments or scopes, and are not used to limit the upper or lower bound of the number of components, nor used to limit the sequence of components. In addition, wherever possible, components/members/steps using the same reference numerals in the drawings and embodiments refer to the same or similar parts. Cross-reference may be made to relevant descriptions of components/members/steps using the same reference numerals or using the same terms in different embodiments.

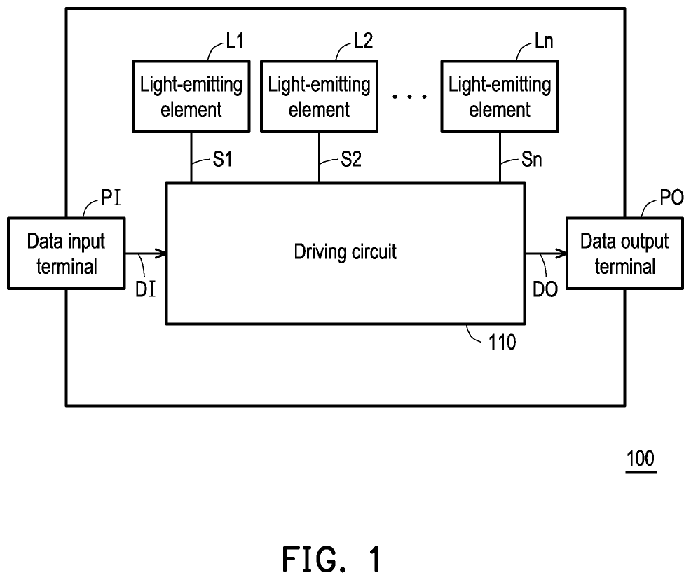

FIG. 1 is a schematic circuit block diagram of a light-emitting device 100 according to an embodiment of the disclosure. In the embodiment shown in FIG. 1, the light-emitting device 100 includes a data input PI, a data output PO, a light unit L1, a light unit L2, . . . , a light unit Ln, and a driving circuit 110. The data input PI may receive an input data DI. The data output PO is adapted to be connected in series to a data input of another light-emitting device (not shown). In other words, the light-emitting device 100 may be connected in series with one or more other light-emitting devices having the same or similar structure to form a display module, and transfer the input data DI utilizing serial transmission. In this embodiment, the driving circuit 110 is coupled to the data input PI, the data output PO, and the light units L1 to Ln, and is configured to receive the input data DI, drive the light units L1 to Ln to emit light, and generate an output data DO. The actual number and arrangement of the light units L 1 to Ln may be determined depending on design requirements/applications. For example, the light-emitting device 100 may be actually packaged in a form of, for example, a seven-segment display, an alphanumeric display, a mix-type display, a dot-matrix display, or other small display arrays, which is not limited by this embodiment. Reference may be made to the embodiments described later for implementation details of the driving circuit 110.

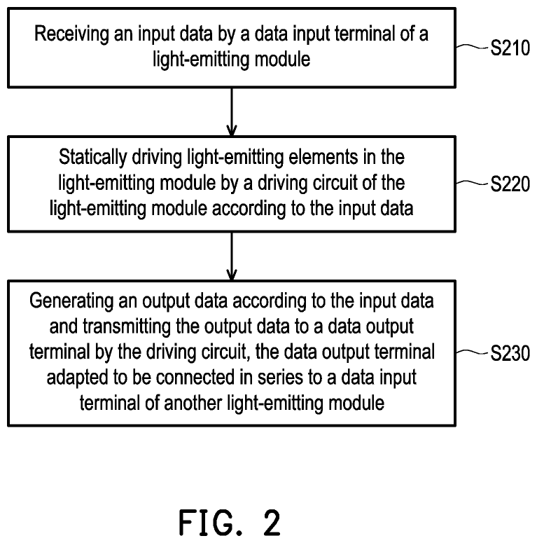

FIG. 2 is a schematic flowchart of a driving method of a light-emitting device according to an embodiment of the disclosure. Reference may be made to the relevant description of FIG. 2 for the light-emitting device 100 shown in FIG. 1. Reference may be made to FIG. 1 and FIG. 2 together. In step S210, the data input PI in the light-emitting device 100 may receive the input data DI. In step S220, the driving circuit 110 in the light-emitting device 100 may statically drive the light units L1 to Ln in the light-emitting device 100 according to the input data DI. For example, in some embodiments, the light-emitting device 100 may be input with the input data DI by a user through the data input PI, and correspondingly send a plurality of driving signals (e.g., a driving signal S1, a driving signal S2, . . . , a driving signal Sn shown in FIG. 1) through the driving circuit 110 according to the input data DI to correspondingly drive the light units L1 to Ln to emit light. The actual number n of the driving signals Si to Sn may be determined depending on applications. In step 5230, the driving circuit 110 may generate the output data DO according to the input data DI and transmit the output data DO to the data output PO.

For example, when the actual data amount of the input data DI is less than or equal to the display range of one light-emitting device (e.g., the light-emitting device 100 shown in FIG. 1), the driving circuit 110 may directly drive the light units L1 to Ln to perform display according to the input data DI. When the actual data amount (e.g., with n pieces of data) of the input data DI is greater than the display range of the light-emitting device 100, the driving circuit 110 may extract partial data in the input data DI (e.g., a first piece of data in the input data DI) to correspondingly drive the light units L1 to Ln to display the partial data, and transmit the remaining data (e.g., with n-1 pieces of data) as the output data DO to the data output PO. Since the data output PO is adapted to be connected in series to the data input of another light-emitting device, when a plurality of (e.g., m) light-emitting devices are connected in series, the input data DI may be received by one data input (e.g., the data input PI) of one of the light-emitting devices (e.g., a first light-emitting device), and the remaining data (with successively decreased data amounts) in the input data DI that has not been displayed is sequentially transferred through the data output of each light-emitting device to the data input of the next light-emitting device (e.g., a second light-emitting device) connected in series, to statically drive each light-emitting device sequentially to perform display. Accordingly, the input/output interfaces required for displaying using one light-emitting device or a plurality of light-emitting devices may be greatly reduced, reducing the cost and program complexity. In addition, in some embodiments, the driving circuit 110 may drive the light units L1 to Ln by a constant current to maintain consistency of brightness of the light units L1 to Ln, improving the service life of the light units L1 to Ln.

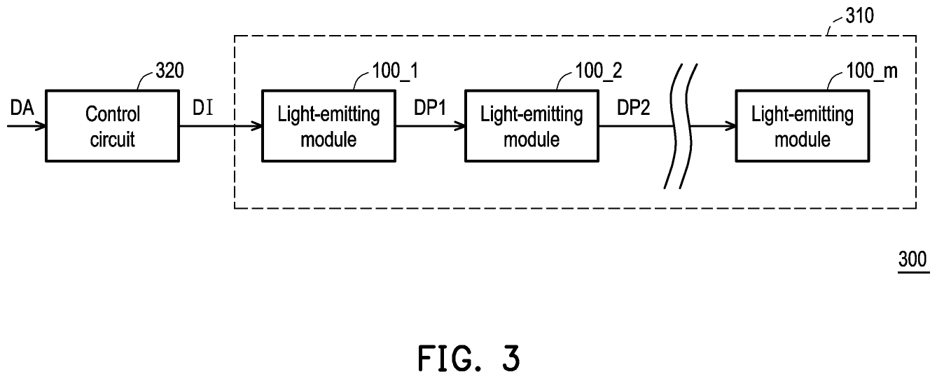

For example, FIG. 3 is a schematic circuit block diagram of a display module 300 according to an embodiment of the disclosure. In the embodiment shown in FIG. 3, the display module 300 includes a display array 310 and a control circuit 320. The display array 310 includes a plurality of light-emitting devices (e.g., a first light-emitting device 100_1, a second light-emitting device 100_2, . . . , and an m^{th} light-emitting device 100_m in the figure) connected in series. The display module 300 shown in FIG. 3 may serve as an example of implementing the light-emitting device 100 shown in FIG. 1 connected in series with other light-emitting devices. Reference may be made to the relevant description of the light-emitting device 100 shown in FIG. 1 for any one of the light-emitting devices 100_1 to 100_m shown in FIG. 3. The actual number m of the light-emitting devices 100_1 to 100_m is greater than or equal to 1, and the number m and the specific arrangement of the light-emitting devices 100_1 to 100_m may be set depending on the actual design. For example, in some embodiments, it is also possible that a plurality of light-emitting devices are connected in parallel to display the same data together, which is not limited by this embodiment.

In this embodiment, the control circuit 320 may be coupled to an input of the display array 310 and configured to generate the input data DI. For example, the control circuit 320 may receive display information DA designated by the user or built in a system (not shown), and serially compile the display information DA into the input data DI that the light-emitting devices 100_1 to 100_m can recognize. Depending on different design requirements, the control circuit 320 may be realized in a form of hardware, firmware, software (i.e., a program), or a combination of multiple of the above three. In terms of the hardware form, the control circuit 320 may be realized as a logic circuit on an integrated circuit. The relevant functions of the control circuit 320 may be realized as hardware utilizing a hardware description language (e.g., Verilog HDL or VHDL) or other suitable programming languages. For example, the related functions of the control circuit 320 may be realized as various logic blocks, modules, and circuits in one or more microcontrollers, microprocessors, application-specific integrated circuits (ASICs), digital signal processors (DSPs), field-programmable gate arrays (FPGAs), and/or other processing units. In terms of the software form and/or firmware form, the relevant functions of the control circuit 320 may be realized as programming codes, for example, realized by utilizing a general programming language (e.g., C, C++, or assembly language) or other suitable programming languages. The programming code may be recorded/stored in a “non-transitory computer-readable medium” including, for example, read-only memory, tape, disk, card, semiconductor memory, programmable logic circuits, and/or storage devices. A computer, central processing unit, microcontroller, or microprocessor may read the programming code from the non-transitory computer-readable medium and execute the same to achieve the relevant functions.

In this embodiment, the display array 310 may completely display the display information DA according to the input data DI. For example, in this embodiment, it is assumed that the data amount of the input data DI is n pieces of data, where n>1 and n>m. In some embodiments, the display module 300 may be driven by the following, for example. The input data DI with n pieces of data is generated by the control circuit 320 and input to the input of the display array 310. The n pieces of data of the input data DI are received by a data input of the first light-emitting device 100_1 in the display array 310. A plurality of light units of the first light-emitting device 100_1 are driven by a driving circuit of the first light-emitting device 100_1 according to a first piece of data in the input data DI to perform display. The remaining n-1 pieces of data in the input data DI are transmitted as an output data DP1 to a data output of the first light-emitting device 100_1. Next, the n-1 pieces of data of the output data DP1 may be received by a data input of the second light-emitting device 100_2 in the display array 310 as an input data of the light-emitting device 100_2. A plurality of light units of the second light-emitting device 100_2 are driven by a driving circuit of the second light-emitting device 100_2 according to a first piece of data in the output data DP1 (i.e., a second piece of data in the input data DI) to perform display. The remaining n-2 pieces of data in the output data DP1 are transmitted as an output data DP2 to a data output of the second light-emitting device 100_2. By analogy, the light-emitting device 100_m may be configured to receive and display an n-m^{th} piece of data in the input data DI. Accordingly, the display array 310 may receive the input data DI through one input. In addition, the display information DA designated by the user or built in the system may be jointly and completely displayed through direct data transmission between the light-emitting devices 100_1 to 100_m connected in series. In the meantime, a great number of I/O ports or individual wiring between the control circuit 320 and each of the light-emitting devices 100_1 to 100_m is not required. Therefore, a low cost, a small volume, and a simple control program can be achieved.

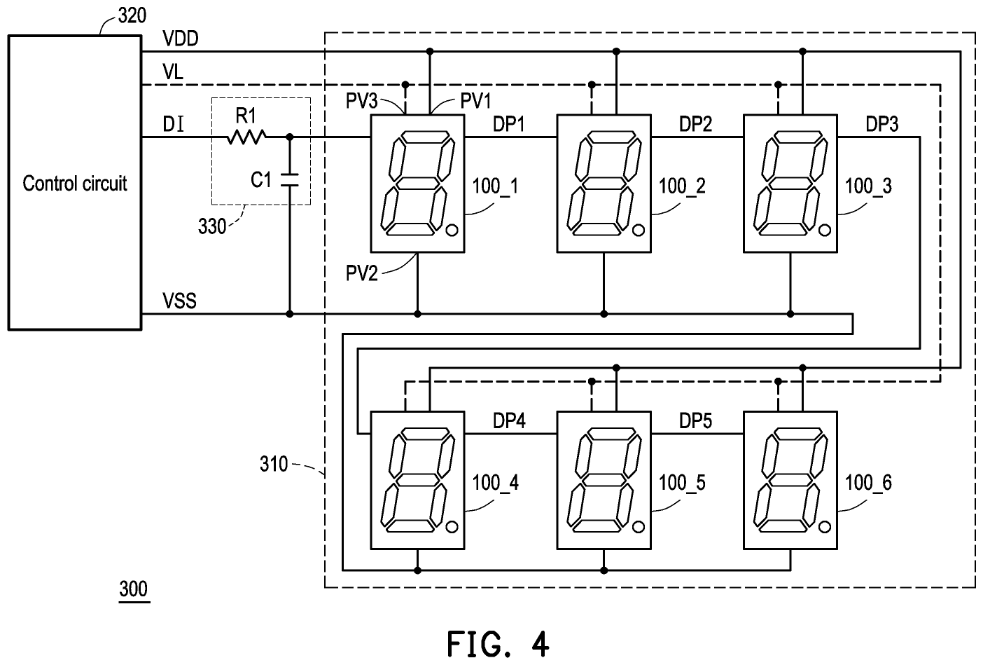

For example, FIG. 4 is a schematic diagram showing an application scenario of the display module 300 shown in FIG. 3 according to an embodiment of the disclosure. In the embodiment shown in FIG. 4, the display module 300 includes the display array 310 and the control circuit 320. The display array 310 includes a light-emitting device 100_1, a light-emitting device 100_2, a light-emitting device 100_3, a light-emitting device 100_4, a light-emitting device 100_5, and a light-emitting device 100_6 connected in series. The display module 300 shown in FIG. 4 may serve as an example of implementing the light-emitting device 100 shown in FIG. 1 connected in series with other light-emitting devices. For any one of the light-emitting devices 100_1 to 100_6 shown in FIG. 4, reference may be made to the relevant description of the light-emitting device 100 shown in FIG. 1 or any one of the light-emitting devices 100_1 to 100_m shown in FIG. 3, which will not be repeated here. For the control circuit 320 shown in FIG. 4, reference may be made to the relevant description of the control circuit 320 shown in FIG. 3, which will not be repeated here. In this embodiment, the light-emitting devices 100_1 to 100_6 are packaged in a form of a seven-segment display, which is not limited by this embodiment.

In this embodiment, the light-emitting devices 100_1 to 100_6 may sequentially receive the input data DI, the output data DP1, the output data DP2, an output data DP3, an output data DP4, and an output data DP5, and correspondingly performs display through a plurality of light units arranged into a form of “8.”. In some embodiments, the display array 310 and the light-emitting devices 100_1 to 100_6 may also each have a first voltage input (e.g., a first voltage input PV1 of the light-emitting device 100_1 in the figure) and a second voltage input (e.g., a second voltage input PV2 of the light-emitting device 100_1 in the figure) to respectively receive a first voltage VDD and a second voltage VSS. For example, the first voltage VDD may be a DC high level, and the second voltage VSS may be a DC low level, a ground level, or other voltage levels different from the first voltage VDD. In some embodiments, the display array 310 and any one of the light-emitting devices 100_1 to 100_6 may also have a third voltage input (e.g., a third voltage input PV3 of the light-emitting device 100_1 in the figure) to receive a third voltage VL. The third voltage VL may, for example, be a voltage level required to drive the light units or other voltage levels different from the first voltage VDD and the second voltage VSS. In this embodiment, the first voltage VDD, the second voltage VSS, and/or the third voltage VL may be provided by the control circuit 320, and may also be provided by other power circuits not shown in other embodiments, to supply power to driving circuits and/or a plurality of light units in the light-emitting devices 100_1 to 100_6. In some embodiments, for example, the first voltage VDD may be 5 volts, the second voltage VSS may be 0 volt, and the third voltage VL may be 3.3 volts, which is not limited by this embodiment.

In some embodiments, the display module 300 and/or any one of the light-emitting devices 100_1 to 100_6 may further include one or more passive elements. For example, one or more passive components may be disposed between any two of the first voltage input, the second voltage input, and the third voltage input of the display array 310 and/or any one of the light-emitting devices 100_1 to 100_6. For example, in some embodiments, a multi-layer ceramic capacitor (MLCC) of 0.1 microfarad (μF) may be disposed in the driving circuit in any one of the light-emitting devices 100_1 to 100_6 to protect a driving chip in the driving circuit. In some embodiments, it is also possible to take a plurality of driving chips as driving circuits, and dispose a plurality of capacitors respectively between ends of each driving chip receiving the first voltage VDD and the second voltage VSS, which is not limited by this embodiment.

In some embodiments, the display module 300 may further include a filter circuit 330. The filter circuit 330 may be a filter in any form, such as a high-pass filter, a low-pass filter, a band-pass filter, and the like, which is not limited by this embodiment. For example, in this embodiment, the filter circuit 330 may be coupled between the control circuit 320 and the input of the display array 310. In this embodiment, the filter circuit 330 may include a resistor R1 and a capacitor C1. A first terminal of the resistor R1 may be coupled to the control circuit 320 to receive the input data DI. A second terminal of the resistor R1 may be coupled to the input of the display array 310, namely the data input of the light-emitting device 100_1. A first terminal of the capacitor C1 may be coupled to the second terminal of the resistor R1, and a second terminal of the capacitor C1 may receive the second voltage VSS. Accordingly, the filter circuit 330 may perform low-pass filtering on the input data DI generated by the control circuit 320 to suppress ripples in the DC.

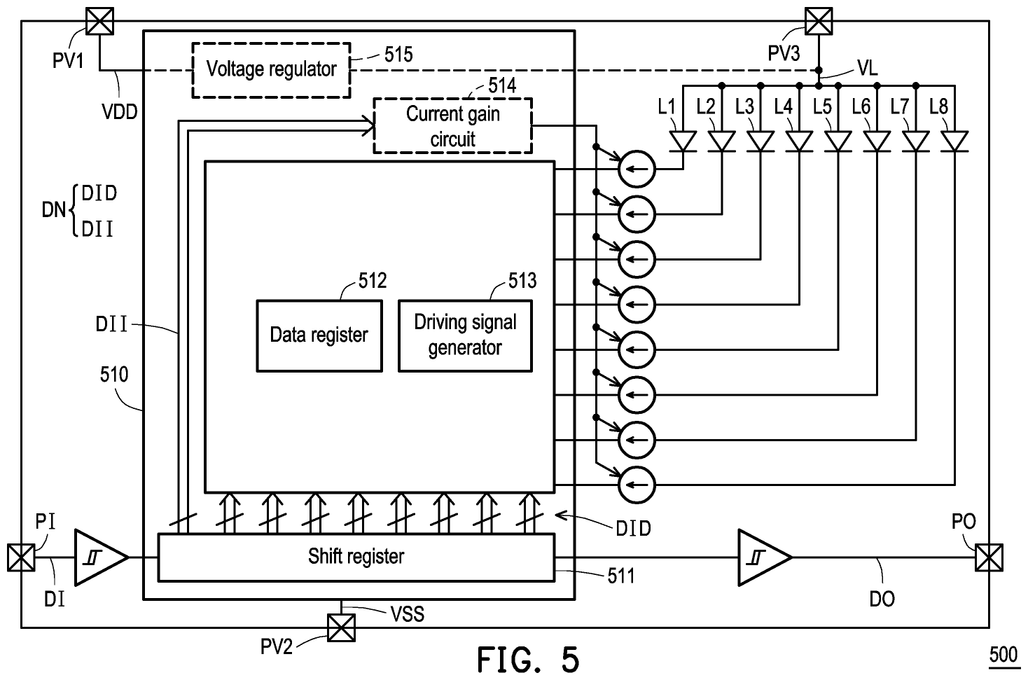

FIG. 5 is a schematic circuit block diagram of a light-emitting device 500 according to another embodiment of the disclosure. In the embodiment shown in FIG. 5, the light-emitting device 500 includes the data input PI, the data output PO, the light unit L1, the light unit L2, the light unit L3, the light unit L4, the light unit L5, the light unit L6, the light unit L7, the light unit L8, and a driving circuit 510. The light-emitting device 500 shown in FIG. 5 may serve as an example of implementing the light-emitting device 100 shown in FIG. 1, any one of the light-emitting devices 100_1 to 100_n shown in FIG. 3, or any one of the light-emitting devices 100_1 to 100_6 shown in FIG. 4. Reference may be made to the relevant description of any one of the data input PI, the data output PO, and the light units L1 to Ln of the light-emitting device 100 shown in FIG. 1 for any one of the data input PI, the data output PO, and the light units L1 to L8 of the light-emitting device 500 shown in FIG. 5. In some embodiments, the light-emitting device 500 may further include other circuit elements, such as a non-inverting Schmitt trigger, a comparator, a filter, or other circuit elements not shown, which is not limited by this embodiment.

In this embodiment, the light-emitting device 500 further includes the first voltage input PV1, the second voltage input PV2, and the third voltage input PV3 to respectively receive the first voltage VDD, the second voltage VSS, and the third voltage VL, and may supply the first voltage VDD and the second voltage VSS to the driving circuit 510 and may supply the third voltage VL to the light units L1 to L8. For the first voltage input PV1, the second voltage input PV2, and the third voltage input PV3 and the first voltage VDD, the second voltage VSS, and the third voltage VL shown in FIG. 5, reference may be made to the first voltage input PV1, the second voltage input PV2, and the third voltage input PV3 and the first voltage VDD, the second voltage VSS, and the third voltage VL shown in FIG. 4, which will not be repeatedly described here. Depending on design requirements, in some embodiments, the light-emitting device 500 may include only the first voltage input PV1 and the second voltage input PV2, namely receive only the first voltage VDD and the second voltage VSS. The driving circuit 510 may include a voltage regulator 515 coupled between the first voltage input PV1 and the light units L1 to L8. The voltage regulator 515 may be configured to adjust the voltage value of the first voltage VDD to generate the third voltage VL according to the first voltage VDD, and may directly supply the third voltage VL to the light units L1 to L8.

In some embodiments, the voltage regulator 515 may be disposed external from the driving circuit 510. Thus, the third voltage VL may be directly provided by the control circuit 320, other power circuits or through an external voltage regulator.

In this embodiment, depending on design requirements, the driving circuit 510 may include a shift register 511, a data register 512, and a driving signal generator 513. The shift register 511 is coupled between the data input PI and the data output PO, and is configured to generate a present-time data DN and the output data DO according to the input data DI. The data register 512 is coupled to the shift register 511, and is configured to store the present-time data DN. The driving signal generator 513 is coupled between the data register 512 and the light units L1 to L8, and is configured to generate a plurality of driving signals according to the present-time data DN to statically drive the light units L1 to L8, respectively. In some embodiments, the driving circuit 510 may drive the light units L1 to L8 by a constant current. For example, in some embodiments, the driving signal generator 513 may further include a pulse width modulation (PWM) signal generator to change an average current (average power consumption) flowing through the light units L1 to L8 by changing the duty ratio of PWM driving signals, namely the proportion of time of switching on or off, during each repeated switching cycle, accordingly controlling the switching of, and brightness of light emitted by, the light units L1 to L8 at the same time.

Depending on design requirements, in some embodiments, the driving circuit 510 may further include a current gain circuit 514 coupled between the shift register 511 and the light units L1 to L8, and configured to adjust a value of the constant current driving the light units L1 to L8. For example, in some embodiments, the present-time data DN generated by the shift register 511 may include a data to be displayed DID and a current gain data DII. The data to be displayed DID may be transmitted to the data register 512 for storage and transmitted to the driving signal generator 513. The current gain data DII may be transmitted to the current gain circuit 514. The current gain circuit 514 may adjust the value of the constant current flowing through the light units L1 to L8 according to the current gain data DII. Accordingly, the driving circuit 510 may generate a PWM driving signal through the driving signal generator 513 according to the data to be displayed DID to drive the light units L1 to L8 to emit light, and also adjust the brightness of light emitted by the light units L1 to L8 according to the data value of the PWM driving signal and the value of the constant current adjusted by the current gain circuit 514 according to the current gain data DII. For example, assuming that the data to be displayed DID corresponding to any one of the light units L1 to L8 is 8 bits, and the current gain data DII is 4 bits, then the brightness of light emitted by one light unit includes 2⁸×2⁴ orders of different degrees of brightness.

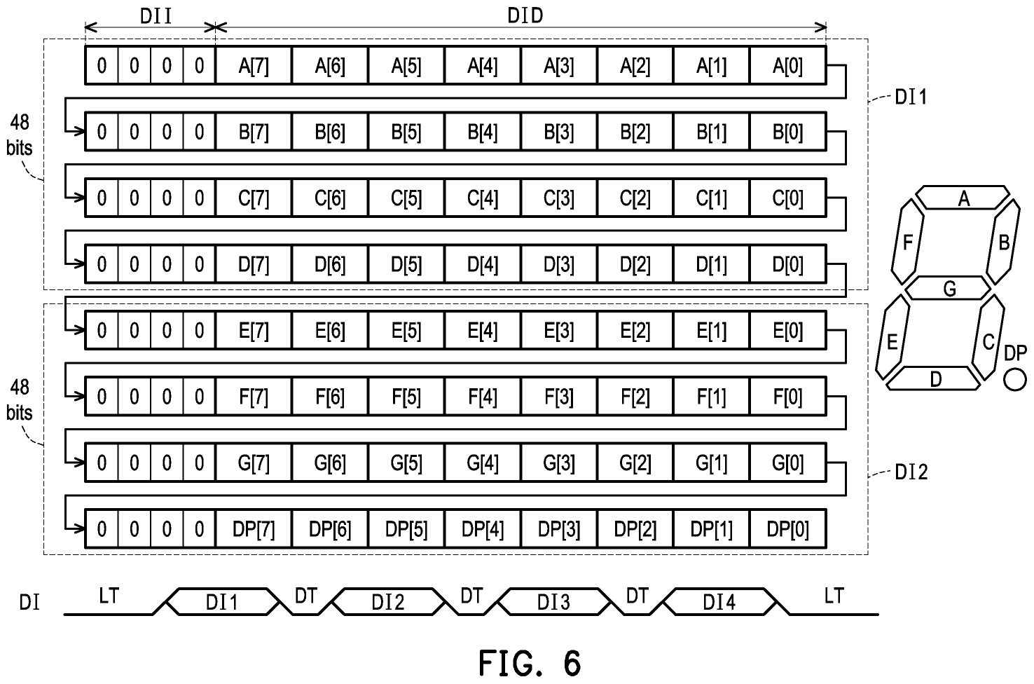

For example, FIG. 6 is a schematic diagram showing distribution and transmission of the input data DI shown in FIG. 5 according to an embodiment of the disclosure. Reference may be made to FIG. 5 and FIG. 6 together. The upper part of FIG. 6 is a schematic diagram exemplifying the actual distribution of a piece of data (96 bits) corresponding to one light-emitting device (e.g., the light-emitting device 500 shown in FIG. 5) and a plurality of light units (a light unit A, a light unit B, a light unit C, a light unit D, a light unit E, a light unit F, a light unit G, and a light unit DP). The lower part of FIG. 6 is a schematic diagram exemplifying transmission of the input data DI (multiple pieces of data) corresponding to at least two light-emitting devices connected in series. The input data DI shown in FIG. 6 may be generated by the control circuit 320 shown in FIG. 3, which is not limited by this embodiment. The input data DI shown in FIG. 6 may serve as an example of implementing the input data DI in any one of the embodiments above. Here, the light-emitting device 500 packaged in a form of a seven-segment display is taken as an example. It is assumed that the light units L1 to L8 shown in FIG. 5 may be arranged into “8.” shown on the right side of the upper part of FIG. 6, namely corresponding to any one of the light units A to G and DP, respectively. In addition, it is assumed that the driving circuit 510 shown in FIG. 5 may receive the current gain data DII of 4 bits and the data to be displayed DID of 8 bits shown on the left side of the upper part of FIG. 6 to correspondingly drive any one of the light units A to G and DP (i.e., the light units L1 to L8) (in FIG. 6, for example, data to be displayed A[0] to A[7] may be configured to drive the light unit A, data to be displayed DP[0] to DP[7] may be configured to drive the light unit DP, and so on and so forth). Then, when a plurality of light-emitting devices are connected in series to form a display array, each of the pieces of data corresponding to the plurality of light units of the plurality of light-emitting devices may be compiled into the input data DI utilizing the serial binary code, and sequentially delivered to the plurality of light-emitting devices through communication of serial transmission to sequentially drive the plurality of light units in the light-emitting devices. The actual number of bits and arrangement of the input data DI merely serve as an example. For example, in some embodiment, it is also possible that the input data DI does not include the current gain data DII, or is other numbers of bits, which is not limited by this embodiment.

In some embodiments, each of the pieces of data corresponding to each of the light-emitting devices in the input data DI may be divided into a plurality of sets of partial data. In some embodiments, the plurality of sets of partial data may be sequentially delivered to the plurality of light-emitting devices according to a transmission time interval DT. In some embodiments, the driving circuit 510 in the light-emitting device 500 shown in FIG. 5 may also include a plurality of driving chips to respectively receive the plurality of sets of partial data in the input data DI, and correspondingly drive a plurality of sets of partial light units in the light units L1 to L8. For example, in some embodiments, the data shown on the left side of the upper part of FIG. 6 may be divided into an input data DI1 (partial data) of the first 48 bits and an input data DI2 (partial data) of the last 48 bits (or divided in other ways). The driving circuit 510 in the light-emitting device 500 shown in FIG. 5 may include two driving chips to respectively receive the input data DI1 and the input data DI2, and correspondingly drive the light units L1 to L4 and the light units L5 to L8 in the light units L1 to L8 (or in other correspondences), reducing the burden of each (or one) driving chip, and reducing the volume of the driving circuit 510. In some embodiments, the plurality of sets of partial data of the input data DI may be sequentially transmitted in a packet form in a first-in-first-out manner after a latch time LT and according to the transmission time interval DT through the serial transmission shown in the lower part of FIG. 6. In some embodiments, the transmission time interval DT may be between 1.2 microseconds (μs) and 3.6 μs, which is not limited by this embodiment. By analogy, when a data output of the light-emitting device 500 is connected in series to a data input of another light-emitting device (not shown), a plurality of sets of partial data (an input data DI3 and an input data DI4) corresponding thereto may also be similarly connected in series and sequentially delivered following the input data DI1 and the input data DI2.

In summary of the foregoing, in the light-emitting device, the display module, and the driving method thereof according to the embodiments of the disclosure, the input data may be received by one data input of the light-emitting device, the plurality of light units may be statically driven by the driving circuit inside the light-emitting device according to the input data, and the output data may be generated according to the input data and transmitted to the data output by the driving circuit. Since the data output is adapted to be connected in series to the data input of another light-emitting device, the plurality of light-emitting devices may accordingly be connected in series to be statically driven sequentially to perform display, to address the requirements for a great number of input/output interfaces in the conventional static scanning, without generating flickering or ghosting in the dynamic driving, or an unstable voltage causing low brightness or uneven display brightness, for example.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A light-emitting device, comprising:
a data input configured to receive an input data;
a data output adapted to be connected in series to a data input of another light-emitting device;
a plurality of light units; and
a driving circuit coupled to the data input, the data output, and the plurality of light units, wherein the driving circuit statically drives the plurality of light units according to the input data, and generates an output data according to the input data and transmits the output data to the data output.

2. The light-emitting device according to claim 1, wherein the driving circuit drives the plurality of light units by a constant current.

3. The light-emitting device according to claim 2, wherein the driving circuit comprises:
a shift register coupled between the data input and the data output and configured to generate a present-time data and the output data according to the input data;
a data register coupled to the shift register and configured to store the present-time data; and
a driving signal generator coupled between the data register and the plurality of light units and configured to generate a plurality of driving signals according to the present-time data to statically drive the plurality of light units, respectively.

4. The light-emitting device according to claim 3, wherein the driving circuit further comprises:
a current gain circuit coupled between the shift register and the plurality of light units and configured to adjust a value of the constant current driving the plurality of light units.

5. The light-emitting device according to claim 1, further comprising:
a first voltage input and a second voltage input respectively receive the first voltage and the second voltage to the driving circuit; and
a third voltage input receives a third voltage to the light units,
wherein voltage levels of the second voltage and third voltage are different from that of the first voltage.

6. The light-emitting device according to claim 5, wherein the driving circuit further comprises:
a voltage regulator coupled to the plurality of light units and configured to generate a third voltage to the plurality of light units according to the first voltage.

7. The light-emitting device according to claim 1, wherein light units are packaged in a form of a seven-segment display, an alphanumeric display, a mix-type display, and a dot-matrix display.

8. A display module, comprising:
a display array comprising a plurality of light-emitting devices according to claim 1 connected in series; and
a control circuit coupled to an input of the display array and configured to generate an input data.

9. The display module according to claim 8, wherein the driving circuit drives the plurality of light units by a constant current.

10. The display module according to claim 8, further comprising:
a filter circuit coupled between the control circuit and the input of the display array and configured to filter the input data.

11. The display module according to claim 10, wherein the filter circuit includes a resistor and a capacitor, one terminal of the resistor is coupled to the control circuit to receive the input data, another one terminal of the resistor is coupled to the input of the display array, a first terminal of the capacitor coupled to the second terminal of the resistor, and a second terminal of the capacitor receive a voltage form the control circuit.

12. The display module according to claim 8, wherein the display array includes
a first voltage input and a second voltage input respectively receive the first voltage and the second voltage from control circuit; and
a third voltage input receives a third voltage according to the first voltage from a voltage regulator;
wherein voltage levels of the first voltage, the second voltage, and third voltage are different.

13. A driving method of a display module, wherein the display module comprises a display array having m light-emitting devices connected in series and a control circuit coupled to the display array, and the driving method comprises:
generating n pieces of data and inputting the n pieces of data to an input of the display array by the control circuit;
receiving the n pieces of data by a data input of a first light-emitting device in the display array; and
driving a plurality of light units of the first light-emitting device according to the n pieces of data, and generating n-1 pieces of data and transmitting the n-1 pieces of data to a data output of the first light-emitting device by a driving circuit of the first light-emitting device,
where m≥1, n≥1, and n≥m.

14. The driving method according to claim 13, wherein the data output of the first light-emitting device is connected in series to a data input of a second light-emitting device in the display array, and the driving method further comprises:
receiving the n-1 pieces of data by the data input of the second light-emitting device; and
driving a plurality of light units of the second light-emitting device according to the n-1 pieces of data, and generating n-2 pieces of data and transmitting the n-2 pieces of data to a data output of the second light-emitting devices by a driving circuit of the second light-emitting device.

15. The driving method according to claim 13, wherein the display module further comprises a filter circuit coupled between the control circuit and the display array, and the driving method further comprises:
filtering the n pieces of data by the filter circuit.

16. The driving method according to claim 13, wherein a driving circuit of at least one of the light-emitting devices in the display array comprises a plurality of driving chips, each of the n pieces of data comprises a plurality of sets of partial data, and the driving method further comprises:
respectively driving the plurality of light units according to the plurality of sets of partial data by the plurality of driving chips.

17. The driving method according to claim 16, wherein the control circuit sequentially delivers the plurality of sets of partial data to the input of the display array according to a transmission time interval.

18. The driving method according to claim 13, further comprising:
generating a present-time data comprising a data to be displayed and a current gain data by a shift register;
adjust a value of the constant current driving the plurality of light units by a current gain circuit according to the current gain data; and
generating a pulse width modulation (PWM) driving signal according to the data to be displayed and adjusting brightness the light units according to the PWM driving signal and the value of the constant current according to the current gain data.

19. The driving method according to claim 13, further comprising:
receiving a current gain data and a data to be displayed to correspondingly drive any one of the plurality of light units by the driving circuit;
each of a plurality of pieces of data to be displayed corresponding to the plurality of light units is compiled into the input data utilizing a serial binary code; and
sequentially delivering the pieces of data to be displayed through a communication of serial transmission to sequentially drive the plurality of light units.
